(19) United States
(12) Patent Application Publication
(10) Pub. No.: US 2015/0153618 A1
(43) Pub. Date: Jun. 4, 2015

(54) LIQUID CRYSTAL DISPLAY PANEL

(71) Applicant: SHENZHEN CHINA STAR OPTOELECTRONICS TECHNOLOGY CO. LTD., Shenzhen, Guangdong (CN)

(72) Inventor: Sikun Hao, Shenzhen (CN)

(21) Appl. No.: 14/240,372

(22) PCT Filed: Jan. 22, 2014
(86) PCT No.: PCT/CN2014/071091

§ 371 Date: Jun. 4, 2014

(30) Foreign Application Priority Data
Aug. 9, 2013 (CN) 201310349432.9

(51) Int. Cl. G02F 1/1343; G02F 1/1335

(52) U.S. Cl. CPC G02F 1/134309; G02F 1/133514

(57) ABSTRACT

The present disclosure relates to the technical field of liquid crystal display, and particularly relates to a liquid crystal display panel that can improve liquid crystal efficiency. The liquid crystal display panel includes an array substrate and a color filter substrate, a liquid crystal layer being sandwiched between the array substrate and the color filter substrate, wherein a pixel electrode of the array substrate has a multi-domain structure including a trunk portion and a branch portion, and a common electrode of the color filter substrate is provided with slits. The slits can enable the dark lines existing in the prior art to be narrowed. The common electrode of the color filter substrate can be improved through being divided by gaps, so that the widths of the dark lines existing in the prior art can be greatly reduced, and the liquid crystal efficiency of the pixels of the vertical alignment display pattern can be improved. Therefore, the vertical alignment display pattern can be better applied in the high-resolution liquid crystal panel.

### FIELD OF THE INVENTION

The present disclosure relates to the technical field of liquid crystal display, and particularly relates to a liquid crystal display panel that can improve liquid crystal efficiency.

### BACKGROUND OF THE INVENTION

Liquid crystal displays have been widely used as display terminals for mobile communication devices, personal computers, televisions and the like, due to the advantages of high display quality, low price, convenience in carrying and the like.

At present, a common liquid crystal display is generally composed of an upper substrate, a lower substrate and a middle liquid crystal layer, each substrate including glass, electrodes and the like. If the upper and lower substrates are both provided with the electrodes, a display with a longitudinal electric field pattern, such as a Twist Nematic (TN) pattern, a Vertical Alignment (VA) pattern, and a Multidomain Vertical Alignment (MVA) pattern that is developed for solving the defect of narrow viewing angles, may be formed. Another type of display is different from the above-mentioned display, and is provided with electrodes that are merely located on one side of the substrates, thus forming a display with a transverse electric field pattern, such as an In-plane Switching (TPS) pattern, a Fringe Field Switching (FFS) pattern and the like.

The thin-film transistor display of VA pattern has been used in large-sized panels of liquid crystal televisions and the like due to the characteristics of high aperture, high resolution, wide viewing angle, and the like. However, in a panel with small size and high resolution, the liquid crystal efficiency of pixels designed with the traditional method is low, so that the thin-film transistor display of VA pattern has not been widely used till now.

FIG. 1 and FIG. 2 shows the electrodes of a traditional liquid crystal display panel used in the display with VA pattern. With reference to FIG. 1, in the traditional liquid crystal display panel, a pixel electrode of a thin-film transistor (TFT) array substrate is formed in a “fishbone” shape. Namely, the whole electrode is divided into a plurality of display areas through two strip-like trunk electrodes (keels) that are vertically crossed with each other, and in each of the display areas strip-like branch electrodes that are mutually separated from each other are arranged. With reference to FIG. 2, in the traditional liquid crystal display panel, an electrode of a color filter (CF) substrate is generally in a film shape, and is used as a common electrode of pixels.

FIG. 3 shows the optical performance of the pixels obtained by using the above-mentioned electrodes. The defect is that two dark lines that are vertically crossed with each other will appear in a middle area of the pixels, because liquid crystals are oriented as being parallel to the penetration axis or absorption axis of a polarizer. The widths of the dark lines can be reduced by shortening the widths of the strip-like trunk electrodes of the pixel electrode of the TFT array substrate. Nevertheless, the dark lines caused by the electrodes of the liquid crystal display panel in the prior art are still wide, thus affecting the liquid crystal efficiency.

### SUMMARY OF THE INVENTION

In view of the foregoing, it can be recognized that the following defects exist in the prior art. In a panel with small size and high resolution, the liquid crystal efficiency of pixels designed by traditional methods is low, and a VA display pattern cannot be widely adopted.

Accordingly, the present disclosure proposes a liquid crystal display panel manufactured by a novel pixel design method applicable to the VA display pattern, so that dark lines that exist in the prior art can be narrowed. The liquid crystal display panel according to the present disclosure may improve the liquid crystal efficiency of the pixels, and broaden the application range of the VA display pattern in the panel with small size and high resolution.

In embodiment 1 according to the present disclosure, a liquid crystal display panel includes an array substrate, a color filter substrate, and a liquid crystal layer sandwiched between the array substrate and the color filter substrate, wherein a pixel electrode of the array substrate has a multi-domain structure including a trunk portion and a branch portion, and a common electrode of the color filter substrate is provided with slits. The slits can enable the dark lines existing in the prior art to be narrowed. In such a manner, this technical solution can improve the liquid crystal efficiency, transmittance, ultraviolet curing speed, and response time.

In embodiment 2 improved based on embodiment 1, the slits are arranged in correspondence to the trunk portion.

In embodiment 3 improved based on embodiment 1 or 2, the shape of the slits is matched with the shape of the trunk portion. In this manner, an optimal effect for narrowing the dark lines can be obtained.

In embodiment 4 improved based on any of embodiments 1 to 3, the slits include one or more first slits extending along a first direction and one or more second slits extending along a second direction, the first direction being vertical to the second direction.

In embodiment 5 improved based on any of embodiments 1 to 4, the slits are configured as having a shape of “ [symbol] ” or double “ [symbol] ”. In embodiment 6 improved based on any of embodiments 1 to 4, the slits are configured as having a shape of “ [symbol] ” or double “ [symbol] ”. Such embodiments are particularly suitable for the liquid crystal display panel provided with multi-domain electrodes.

In embodiment 7 improved based on any of embodiments 1 to 6, bridges are arranged between different portions of the common electrode which are partitioned by the slits. The bridges can reduce the resistance increased by gaps as formed, and further optimize the liquid crystal display panel. This technical solution can improve the resistance, image uniformity, charging property and transmittance of the common electrode.

In embodiment 8 improved based on any of embodiments 1 to 7, the widths of the slits are within a range of 3 μm to 5 μm. The beneficial effects of such slits will be illustrated below in conjunction with the diagrams as provided.

In embodiment 9 improved based on any of embodiments 1 to 8, the widths of the slits are within a range of 4 μm to 5 μm.

In embodiment 10 improved based on any of embodiments 1 to 9, the multi-domain structure has four domains or eight domains.

According to the present disclosure, the common electrode of the color filter substrate can be improved through being divided by gaps, so that the widths of the dark lines existing in the prior art can be greatly reduced, and the liquid crystal efficiency of the pixels of the vertical alignment display pattern can be improved. Therefore, the vertical alignment display pattern can be better applied in the high-resolution liquid crystal panel.

In embodiments improved based on the present disclosure, the bridges are arranged between the portions of the common electrode which are partitioned by gaps, so that the resistance increased by the gaps can be reduced, and the common electrode of the liquid crystal display panel can be further optimized.

The above-mentioned technical features may be combined in various appropriate manners or substituted by equivalent technical features, as long as the objective of the present disclosure can be fulfilled.

### BRIEF DESCRIPTION OF THE DRAWINGS

The present disclosure will be described in more detail below based on nonfinite examples with reference to the accompanying drawings. In the drawings:

FIG. 1 schematically shows structure of a pixel electrode of a thin-film transistor (TFT) array substrate of a liquid crystal display panel in the prior art;

FIG. 2 schematically shows structure of a common electrode of a color filter (CF) substrate of the liquid crystal display panel in the prior art;

FIG. 3 shows optical effect of an electrode structure of the liquid crystal display panel as shown in FIG. 1 and FIG. 2;

FIG. 4 shows a schematic diagram of a pixel electrode structure of a thin-film transistor (TFT) array substrate of a liquid crystal display panel according to the present disclosure;

FIG. 5 schematically shows structure of a common electrode of a color filter (CF) substrate of the liquid crystal display panel according to the present disclosure;

FIG. 6 shows electrodes and effect thereof in the liquid crystal display panel according to the present disclosure;

FIG. 7 shows the display size of the liquid crystal display panel according to the present disclosure, in order to illustrate liquid crystal efficiency in conjunction with the specification;

FIG. 8 shows a liquid crystal arrangement effect obtained by the liquid crystal display panel according to the present disclosure;

FIG. 9 shows transmittance and azimuth angles of new pixels resulted from the liquid crystal display panel according to the present disclosure;

FIG. 10 shows an example improved partially based on a common electrode of the liquid crystal display panel of the present disclosure; and

FIG. 11 shows an example improved partially based on the common electrode of the liquid crystal display panel of the present disclosure.

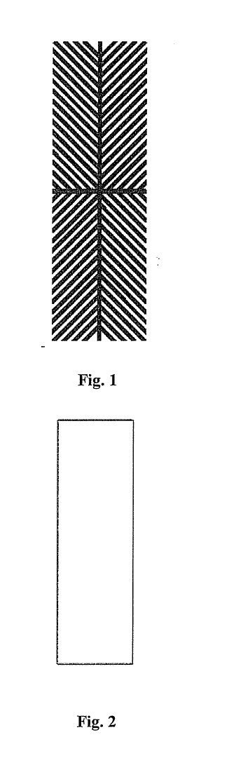

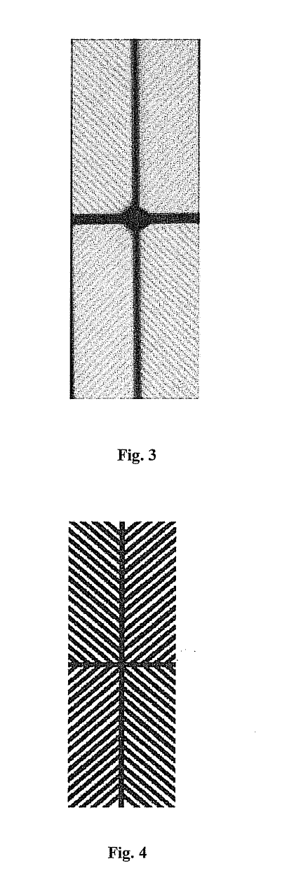

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

FIG. 4 schematically shows the structure of a pixel electrode of a thin-film transistor (TFT) array substrate of a liquid crystal display panel according to the present disclosure. The pixel electrode is arranged on one side of a liquid crystal layer where a TFT is arranged, and is used for the array substrate. The pixel electrode of the TFT array substrate is formed in a “fishbone” shape. Namely, the whole electrode is divided into a plurality of display areas through strip-like trunk electrode portions that are vertically crossed with each other, and in each of the display areas strip-like branch electrodes that are mutually separated from each other are arranged.

FIG. 5 schematically shows the structure of a common electrode of a color filter (CF) substrate of the liquid crystal display panel according to the present disclosure. The common electrode is arranged on one side of the liquid crystal layer where a CF is arranged. The common electrode is provided with slits, which divide the common electrode into different portions. The slits may be arranged in a manner of corresponding to the strip-like trunk electrode portions of the pixel electrode shown in FIG. 4 respectively.

The slits may include one or more first slits extending along a first direction, and one or more second slits extending along a second direction which is vertical to the second direction.

In an example shown in FIG. 5, the shape of the slits is matched with the shape of the strip trunk electrode portions of the pixel electrode shown in FIG. 4. The slits may include two straight slits which are transverse with each other, particularly vertical to each other.

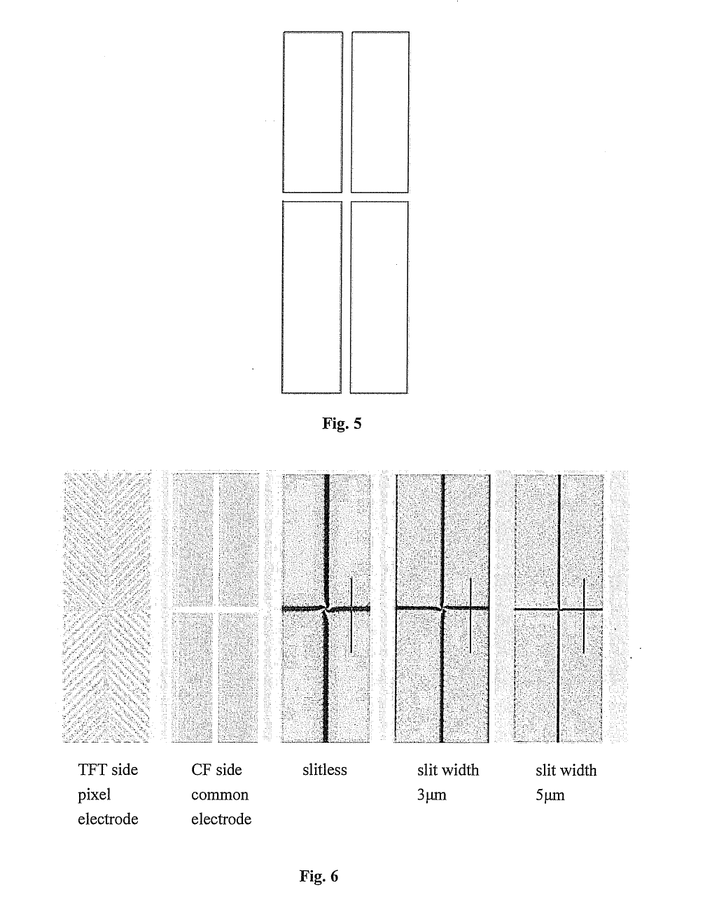

FIG. 6 shows electrodes and effects thereof in the liquid crystal display panel according to the present disclosure. The trunk width of the trunk portion of the pixel electrode (i.e., the keel) of all the pixels is 9 μm. With the increase of the widths of the slits of the common electrode, the widths of dark lines are reduced. In the absence of the slits, the widths of the dark lines are 7.4 μm; when the widths of the slits are 3 μm, the widths of the dark lines are 4.2 μm; and when the widths of the slits are 5 μm, the widths of the dark lines are 2 μm. With respect to the manufacturing process, an additional mould is required for the slits of the common electrode at the CF side.

For example, a desirable effect may also be achieved when the widths of the slits of the common electrode are 4 μm.

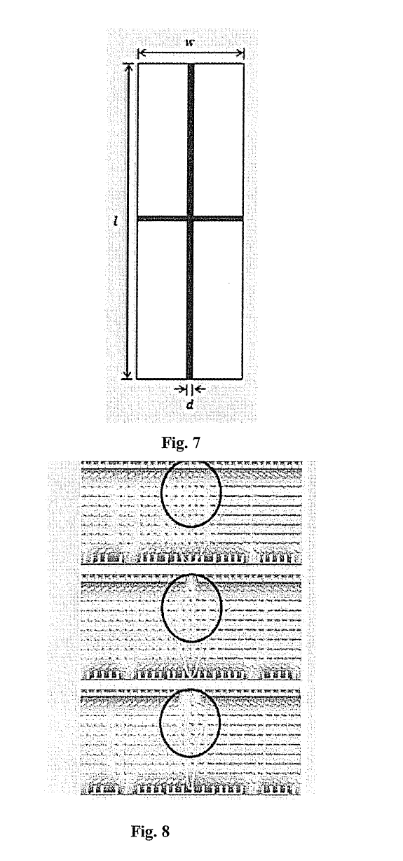

FIG. 7 shows a display size of the liquid crystal display panel according to the present disclosure. The liquid crystal efficiency will be illustrated below in conjunction with FIG. 7, wherein w is display width, l is display length, and d is the width of a dark line.

| | | | liquid crystal efficiency | |
|---|---|---|---|---|
| ppi (pixel/inch) | w (μm) | l (μm) | ITO without slits | ITO with slits |
| 50 | 169.3 | 508.0 | 96% | 98% |
| 100 | 84.7 | 254.0 | 94% | 97% |
| 150 | 56.4 | 169.3 | 91% | 96% |
| 200 | 42.3 | 127.0 | 88% | 94% |
| 250 | 33.9 | 101.6 | 85% | 92% |
| 300 | 28.2 | 84.7 | 82% | 91% |

$$liquid crystal efficiency = \frac{l w - ( l + w ) d + {d}^{2}}{l w} 100 \%$$

According to simulations, for the ITO without slits, dₘₐₓ is equal to 4 μm, and for the ITO with slits, dₘₐₓ is equal to 2 μm. The liquid crystal efficiency is 100% in the portions without the keels, and is 0 in the portions with the keels.

FIG. 8 shows a liquid crystal arrangement effect obtained by the liquid crystal display panel according to the present disclosure. It is thus clear that, with the increase of the widths of the slits, the transmittance curve becomes narrow and sharp. The widths of the slits can significantly affect the electric field nearby the ITO, and also affect the orientation of the liquid crystals.

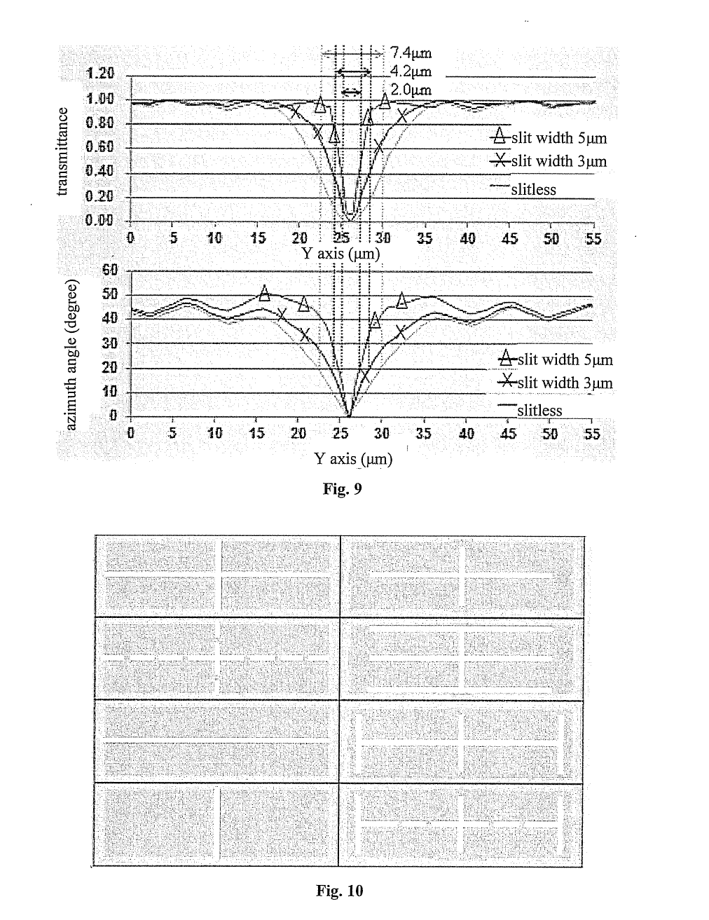

FIG. 9 shows transmittance and azimuth angles of new pixels resulted from the liquid crystal display panel according to the present disclosure. It is thus clear that, with the increase of the widths of the slits, the widths of the dark lines are reduced. The dark lines mainly depend on the azimuth angle of the liquid crystal orientation, and the slits may generate narrower dark lines.

The following table may be used for interpreting the effects brought by the liquid crystal display panel according to the present disclosure. In the table, X indicates very bad, Δ indicates bad, o indicates ordinary, and □ indicates good

| | common electrode design | |
|---|---|---|
| Item | of color filter substrate | Result |
| liquid crystal efficiency | ITO without slits → ITO with slits | X→□ |
| transmittance | ITO without slits → ITO with slits | X→□ |
| ultraviolet curing time | ITO without slits → ITO with slits | X→□ |
| response time | ITO without slits → ITO with slits | X→◯ |

It is thus clear that the design of ITO with slits can improve the following performances: liquid crystal efficiency, transmittance, ultraviolet curing speed, and response time.

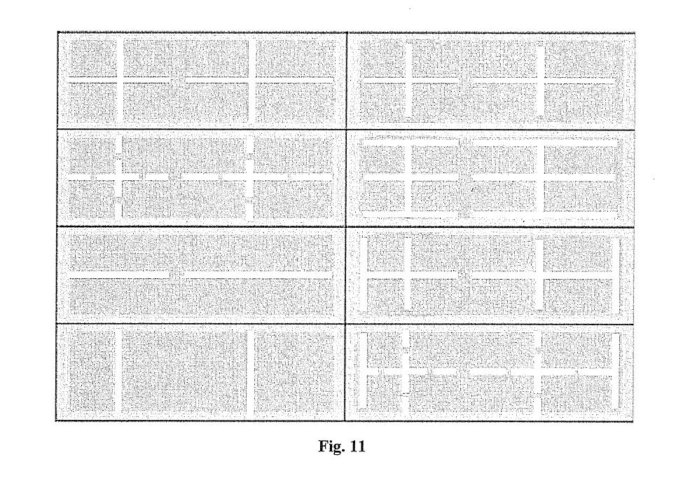

FIG. 10 and FIG. 11 show examples improved partially based on the common electrode of the present disclosure. Specifically, FIG. 10 shows the slit pattern of a 4-domain common electrode, wherein the slits may be in shape of “ [symbol] ” or “ [symbol] ” (both Chinese characters). In addition, FIG. 11 shows the slit pattern of an 8-domain common electrode, wherein the slits may be in shape of double “ [symbol] ” or double “ [symbol] ”.

Because the arrangement of the slits will correspondingly lead to rise of the resistance of the electrode, bridges may be arranged between different portions of the common electrode which are partitioned by the slits, as shown in FIG. 10 and FIG. 11, in order to optimize the electrode.

The following table may be used for interpreting the effects brought by the preferred examples of the common electrode according to the present disclosure. In the table, X indicates very bad, Δ indicates bad, o indicates ordinary, and □ indicates good.

| Item | common electrode | result |
|---|---|---|
| common electrode resistance | non-bridged → bridged | X→□ |
| image uniformity | non-bridged → bridged | X→□ |
| charging | non-bridged → bridged | X→□ |
| transmittance | non-bridged → bridged | X→◯ |

It is thus clear that the improved solutions may improve the following performances of the common electrode: resistance, image uniformity, charging property and transmittance of the common electrode.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. A liquid crystal display panel, including an array substrate, a color filter substrate, and a liquid crystal layer sandwiched between the array substrate and the color filter substrate, wherein a pixel electrode of the array substrate has a multi-domain structure including a trunk portion and a branch portion, and a common electrode of the color filter substrate is provided with slits.

2. The liquid crystal display panel according to claim 1, wherein the slits are arranged in correspondence to the trunk portion.

3. The liquid crystal display panel according to claim 2, wherein the shape of the slits is matched with the shape of the trunk portion.

4. The liquid crystal display panel according to claim 1, wherein the slits include one or more first slits extending along a first direction and one or more second slits extending along a second direction, the first direction being vertical to the second direction.

5. The liquid crystal display panel according to claim 2, wherein the slits include one or more first slits extending along a first direction and one or more second slits extending along a second direction, the first direction being vertical to the second direction.

6. The liquid crystal display panel according to claim 3, wherein the slits include one or more first slits extending along a first direction and one or more second slits extending along a second direction, the first direction being vertical to the second direction.

7. The liquid crystal display panel according to claim 1, wherein the slits are configured as having a shape of “ [symbol] ” or double “ [symbol] ”.

8. The liquid crystal display panel according to claim 2, wherein the slits are configured as having a shape of “ [symbol] ” or double “ [symbol] ”.

9. The liquid crystal display panel according to claim 3, wherein the slits are configured as having a shape of “ [symbol] ” or double “ [symbol] ”.

10. The liquid crystal display panel according to claim 1, wherein the slits are configured as having a shape of “ [symbol] ” or double “ [symbol] ”.

11. The liquid crystal display panel according to claim 2, wherein the slits are configured as having a shape of “ [symbol] ” or double “ [symbol] ”.

12. The liquid crystal display panel according to claim 3, wherein the slits are configured as having a shape of “ [symbol] ” or double “ [symbol] ”.

13. The liquid crystal display panel according to claim 1, wherein bridges are arranged between different portions of the common electrode which are partitioned by the slits.

14. The liquid crystal display panel according to claim 2, wherein bridges are arranged between different portions of the common electrode which are partitioned by the slits.

15. The liquid crystal display panel according to claim 3, wherein bridges are arranged between different portions of the common electrode which are partitioned by the slits.

16. The liquid crystal display panel according to claim 1, wherein the widths of the slits are within a range of 3 μm to 5 μm.

17. The liquid crystal display panel according to claim 2, wherein the widths of the slits are within a range of 3 μm to 5 μ.m.

18. The liquid crystal display panel according to claim 3, wherein the widths of the slits are within a range of 3 μm to 5 μm.

19. The liquid crystal display panel according to claim 16, wherein the widths of the slits are within a range of 4 μm to 5 μm.

20. The liquid crystal display panel according to claim 1, wherein the multi-domain structure has four domains or eight domains.
